(19) United States
(12) Patent Application Publication
(10) Pub. No.: US 2003/0109188 A1
(43) Pub. Date: Jun. 12, 2003

(54) Penetration resistant fabric

(76) Inventors: Rudiger Hartert, Wuppertal (DE); Christian Bottger, Remscheid (DE); Achim Fels, Wuppertal (DE); Michael J Buckstein, North York (CA); Shekoufeh Shahkarami, Kitchener (CA); Andre Ennemond Beth, Etobicoke (CA); David Verlin Cunningham, Mississauga (CA)

Correspondence Address: Shoemaker and Mattare, Suite 1203 Crystal Plaza Building 1, 2001Jefferson Davis Highway, Arlington, VA, 22202-0286, US

(21) Appl. No.: 10/110,834

(22) PCT Filed: Aug. 17, 2001
(86) PCT No.: PCT/CA01/01162

(51) Int. Cl. B32B 3/00; B32B 5/02; B32B 9/00; B32B 27/04; B32B 27/12

(52) U.S. Cl. 442/135; 442/59; 442/134; 2/2.5

(57) ABSTRACT

A laminated fabric for penetration resistant e.g. ballistic applications. The fabric comprising a fabric of penetration resistant yarns having a linear density in the range from 100 to 700 dtex, said yarns being woven in a satin weave. The woven fabric is coated on at least one-side with a polymeric material in a micro-lamination process, the coating material being from 0.5 to 20%

### FIELD OF THE INVENTION

The present invention relates to a laminated fabric for penetration resistant applications e.g. ballistic resistant applications, formed from a fabric that is woven in a satin weave and which is coated on one or both sides with a polymeric material.

### BACKGROUND TO THE INVENTION

Penetration resistant fabrics, especially in the form of bullet-proof vests, are used in the protection of areas of the body, most particularly areas of the body that are vulnerable to serious or fatal injuries. The penetration resistant fabrics are intended to stop bullets, shell fragments or other projectiles, as well as sharp or pointed instruments, from causing injury by penetrating the body of the wearer. Such fabrics are well known, and are typically formed from polyamide (nylon) or aramid fibres that are woven to form the fabric. A typical fabric is so called a plain weave fabric, in which the warp and weft yarns cross alternately over and under every other yarn. Multiple layers of such plain weave fabric are used. However, as the yarns are closely interwoven, there is little freedom for movement of the yarns when impacted by a bullet. In addition, penetration resistant vests formed with such a weave tend to be heavy and hot to wear.

Other methods for the weaving of yarns for penetration resistant applications are known, including the use of satin weaving. Satin weaving is known, and differs from plain weaving in that the warp and weft yarns do not go over and under each adjacent yarn. Use of satin weaving in bullet-resistant woven fabrics is known, being disclosed in published Japanese Patent Application No. 61-275440, published Dec. 5, 1986, which discloses use of a 4-8 pitch in the weaving. The use of satin weaving results in a lighter weight and improved penetration resistant fabric.

Other weaving techniques for use in penetration resistant fabrics are also known.

Notwithstanding the penetration resistant fabrics that are available, new and improved fabrics that are of superior penetration resistance and lighter in weight would be useful.

### SUMMARY OF THE INVENTION

Laminates for penetration resistant applications with improved penetration characteristics and comfort have now been found.

Accordingly, an aspect of the present invention provides a laminated fabric for penetration resistant applications comprising a fabric woven with high performance yarns having a linear density in the range from 100 to 700 dtex, said yarns being woven in a satin weave, said woven fabric being coated on at least one-side with a polymeric material, the polymeric material coated on the woven fabric being from 0.5 to 20% by weight of the woven fabric.

In a preferred embodiment of the laminated fabric of the invention, the woven fabric is micro-laminated with said polymeric material.

In further embodiments, the fabric is coated on one side or the fabric is coated on both sides.

In other embodiments, the coating is a continuous coating or the coating is a discontinuous coating.

In another embodiment, the polymeric material of the coating amounts to from 1 to 10% by weight of the woven fabric.

In a further embodiment, only the outer filaments of the penetration resistant yarns are coated with the polymeric material.

In a still further embodiment, the fabric has a weight from 50 to 200 g/m².

In yet another embodiment, the Walz fabric density of the woven fabric is from 8 to 25%.

In further embodiments, the polymeric material is a thermoplastic or elastomeric material or the polymeric material is formed from a thermoset material.

In still further embodiments, the penetration resistant yarn consists of at least one of aramid, polyethylene and poly-p-phenylene benzobisoxazole yarn.

In other embodiments, the pitch (harness) of the satin woven fabric is from 5 to 9.

In another embodiment, the satin woven fabric has a jump count (progressive number) from 2 to 7.

In a further embodiment, the penetration resistant yarn has a tenacity of at least 1375 mN/tex.

Another aspect of the present invention provides a penetration resistant article comprising a plurality of laminated woven fabrics, said woven fabrics being laid one upon the other to form a packet of laminated fabrics, each of said laminated fabrics comprising a fabric woven with high performance yarns having a linear density in the range from 100 to 700 dtex, said yarns being woven in a satin weave, said woven fabric being coated on at least one-side with a polymeric material, the polymeric material coated on the woven fabric being from 0.5 to 20% by weight of the woven fabric. In preferred embodiments of the penetration resistant article, the laminated fabrics in the packet are joined with each other. For example, the laminated fabrics in the packet are joined by quilting, gluing or other fixing means.

In an embodiment, two or more fabrics are joined with each other by lamination.

### DETAILED DESCRIPTION OF THE INVENTION

The present invention relates to a laminated fabric for penetration resistant applications. The fabric is woven in a satin weave and consists of penetration resistant yarns having a linear density in the range of from 100 to 700 dtex. The woven fabric is continuously or discontinuously coated on one or both sides with a polymeric material, especially using a micro-lamination process. The amount of coating material may be varied over a wide range, especially amounts of 0.5 to 20% by weight of the woven fabric. Small amounts of coating are preferred.

Reference is made herein to the coating of the woven fabric. In some instances, the coating may encompass individual fibres of the woven material. However, the coating may only adhere or contact the surface of the fibres, without encompassing the fibres.

As used herein, micro-lamination is defined as a lamination where the bonding medium content is low, less than 10% of the total laminate content, and the bonding agent coats only one surface of the yarns.

The continuous or discontinuous layer is comprised of a thermoplastic resin, an elastomeric resin, a thermosetting resin or combinations of such resin, all of which are referred to herein as polymeric material or coating material. A wide variety of polymeric materials may be used. In particular, any coating material that will adhere to the fibers may be used. However, the nature of the coating material may affect whether a continuous or discontinuous layer of the material may be applied. For example, coating materials with high flexibility and low modulus may be used uniformly over the fabric i.e. as a continuous coating. Stiffer and more inflexible coating materials are most preferably applied in a discontinuous manner i.e. as a discontinuous coating, in order to allow the yarns of the fabric to move. Movement of the yarns is believed to be important with respect to the present invention.

The coating material that may be used includes all multi-component coating materials that result in a self-curing (cross-linked) coating, using air, radiation, heat or catalyst curing techniques, as well as single component systems such as hot melts and heat-tack polymers. The coating material may be in the form of powders, a web e.g. a lace or spun web, adhesives, films which may be both uniform or perforated, and hot melt materials. The matrix materials of the coatings preferably have low modulii.

A wide variety of elastomeric materials and formulations may be utilized in this invention as the coating materials. For example, any of the following elastomeric materials may be employed: polybutadiene, polyisoprene, natural rubber, ethylene-propylene copolymers ethylene/propylene/diene terpolymers, polysulfide polymers, polyurethane elastomers, chlorosulfonated polyethylene, polychloroprene and polyvinyl chloride having dioctyl phthalate or other plasticizers well known in the art, butadiene/acrylonitrile elastomers, poly(isobutylene-coisoprene), polyacrylates, polyesters, polyethers, fluoroelastomers, silicone elastomers, thermoplastic and copolymers of ethylene.

Other suitable matrix materials for the coatings include thermoplastic polymers e.g. polyethylenes, cross-linked polyethylenes, polypropylenes, ethylene copolymers, propylene copolymers and other olefin polymers and copolymers. Examples of other matrix materials include unsaturated polyesters, phenolics, polybutyrals, epoxy resins and polyurethane resins.

Low modulus elastomeric material may be compounded with fillers such as carbon black, silica, or glass microballoons, or extended with oils and vulcanized by sulfur, peroxide, metal oxide or radiation cure systems using methods well known to rubber technologists. Blends of different elastomeric materials may be used, or one or more elastomeric materials may be blended with one or more thermoplastic polymers. High density, low density, and linear low density polyethylene may be cross-linked to obtain a material of appropriate properties, either alone or as blends.

The amount of the coating material may vary over a wide range, and especially over the range of 0.5-20% by weight of the woven fabric, and more particularly 1-10% by weight.

A wide variety of methods of application may be used, which are generally referred to herein as micro-lamination coating methods. Examples of such methods include the use of sprays, roll coating, silk screening, dipping, knifing onto the fabric, transfer to a release paper and then to the fabric, and heat lamination. Heat lamination is used with films, which may be thermoplastic or thermoset or elastomeric films. Moreover, the films may be continuous, perforated, slit or split and expanded. In addition, the films may be a spun bonded product.

A wide variety of fibres may be used in the weaving of the fabric but such fibres should have a tenacity of at least 1375 mN/tex and a tensile modulus of at least 55 GPa. In embodiments, the yarn has a tenacity of at least 1900 mN/tex. In preferred embodiments of the invention, the yarn is formed from aramid, extended chain polyethylene or poly-p-phenyl benzobisoxazole (PBO).

The satin woven fabric preferably has a harness of from 5-9 and a jump count of from 2-7. In preferred embodiments, the satin weave of the woven fabric is preferably a seven harness satin weave with a jump count of 3 or 4. Alternatively, the satin weave may have a predominance of yarn floats that are 5 or more in either the weft, warp or both directions.

As discussed above, the coating may be a continuous or discontinuous coating, and the fabric may be coated on one or both sides by the polymeric material. However, in embodiments where the polymeric material is a thermoset material, the coating is a discontinuous coating and not a continuous coating. In preferred embodiments, only outer filaments of the fabric are coated with the polymeric material.

In preferred embodiments of the invention, the fabric has a weight of from 50-200 g/m². In addition, it is preferred that the fabric density, as measured by the method of Walz referred hereinafter, be in the range of 8-25%.

In preferred embodiments of the invention, the penetration resistant article comprises several laminated fabrics as described herein. Such laminated fabrics are laid one upon the other to form a packet of the laminated fabrics. Preferably, the laminated fabrics are joined with each other e.g. by quilting, gluing or other means of fixing the laminated fabrics together, including using a so-called centre cross. Alternatively, two or more fabrics may be joined together by lamination.

The present invention is illustrated by the following examples.

### EXAMPLE 1

Twaron™ 550 dtex f 500, type 2040/2000 (warp/weft) yarn was woven into a Satin ⅙ (3) fabric, 14.2 threads per cm (warp/weft), 160 g/m² fabric with a density (Walz) of 20%. Walz density is determined by the equation

DG%=(dₖ+dₛ)².fₖ.fₛ

where DG=fabric density, k=warp, s=weft, d=solid diameter of warp or weft yarn in mm, f=number of ends of picks/cm.

Solid yarn diameter is calculated as follows:

$${d}_{k , s} = \frac{√ {dtex}_{k , s}}{88.5 √ specific gravity in g \text{/} {cm}^{3}}$$

This formula is particularly derived for plain weave fabrics. For satin fabrics as describe herein, the density should be multiplied by a factor to convert to the different weave, 0.49 being used for 4/1 satin fabrics.

Two layers of this fabric were laminated together on a Perkins calendar at a nominal pressure of 27.2 metric tons and roll temperature of 177° C. The coating film used was a spun bond adhesive, composed of medium density polyethylene. The adhesive has a weight of 12 g/m². The top fabric was wrapped over 75% of the top heated roll to bring the temperature of the fabric close to 177° C. before the nip point. The lower fabric was similarly wrapped around the lower heated roll to raise its temperature. The spun bond adhesive layer was fed between the layers of hot fabric at the nip point. After lamination, the fabric was immediately cooled and rolled up on a take-up roll.

Thirteen layers (400×400 mm) of the laminated article thus obtained were fixed with a 10 cm center-cross, giving a total shoot-pack weight of approximately 4250 g/m².

The V₅₀ was determined using 9×19 PARA FMJ bullets, where V₅₀ is the velocity at which the probability of penetration of the fabric is 50%. The V₅₀ obtained for the panel was 462 m/s.

### EXAMPLE II

The fabric of Example 1 was one-side coated with a coating of polyethylene film having a thickness of 10 μm, at 28 bar/185° C., and a speed of 3 m/min in a double-belt press. The coating content was 6% by weight.

Twenty six layers (400×400 mm) of this coated fabric were fixed with a 10 cm center-cross, giving a total shoot-pack weight of about 4500 g/m². The V₅₀ obtained for the panel was 469 m/s.

### EXAMPLE III

The fabric of Example 1 was one-side coated with 25 μm of polyethylene film at 28 bar/185° C., and a speed of 3 m/min in a double-belt press. The coating resin content was 15%.

Twenty four layers (400×400 mm) of this fabric were fixed with a 10 cm center-cross, giving a total shoot-pack weight of about 4500/m². The V₅₀ obtained for the panel was 435 m/s.

### COMPARATIVE EXAMPLE I

Twenty six layers (400×400 mm) of the satin fabric of Example 1, used as woven and without a coating, were fixed with a 10 cm center-cross, to give a total shoot-pack weight of about 4240 g/m². The V₅₀ obtained for the layered fabric panel was 451 m/s.

### COMPARATIVE EXAMPLE II

Twaron™ 550 dtex f500, type 2040/2000 (warp/weft) was woven into a plain fabric having 14.2 threads per cm (warp and weft), 160 g/m² fabric with a density (Walz) of 43%.

Twenty-six layers (400×400 mm) of this fabric were fixed with a 10 cm center-cross, giving a total shoot-pack weight of about 4240 g/m². The V₅₀ obtained was 429 m/s.

It is to be expected that the ballistic performance of a structure will be adversely affected by applying coatings to the fabric. However, the above examples surprisingly show that the V₅₀ values, when weight corrected, obtained in Examples I and II were superior to those obtained in Comparative Example I. Thus, improved performance was obtained with a coating applied by micro lamination. Increasing the amount of the coating does result in a lowering of the V₅₀ value, as illustrated by Example III.

It should also be noted that Comparative Example I is a fabric of a very open construction, which provides good penetration resistance but which is nearly impossible to process into penetration resistant articles.

It is believed that the lamination process reduces the trauma effect on impact of bullets, due to the additional stability obtained by the resin.

The penetration resistant articles of the present invention are substantially more flexible more than the fabric described in Comparative Example II. In addition, the laminates of Example I show improved usability, ballistic resistance and improve breathability, compared with the standard construction as represented by Comparative Example II.

1. A laminated fabric for penetration resistant applications comprising a fabric woven with high performance yarns having a linear density in the range from 100 to 700 dtex, said yarns being woven in a satin weave, said woven fabric being coated on at least one-side with a polymeric material, the polymeric material coated on the woven fabric being from 0.5 to 20% by weight of the woven fabric.

2. The laminated fabric of claim 1 in which the woven fabric is micro-laminated with said polymeric material.

3. The laminated fabric of claim 1 or claim 2 in which the fabric is coated on one side.

4. The laminated fabric of claim 1 or claim 2 in which the fabric is coated on both sides.

5. The laminated fabric of any one of claims 1-4 in which the coating is a continuous coating.

6. The laminated fabric of any one of claims 1-4 in which the coating is a discontinuous coating.

7. The laminated fabric of any one of claims 1-6 in which the polymeric material of the coating amounts to from 1 to 10% by weight of the woven fabric.

8. The laminated fabric of any one of claims 1-7 in which only the outer filaments of the penetration resistant yarns are coated with the polymeric material.

9. The laminated fabric of any one of claims 1-8 in which the fabric has a weight from 50 to 200 g/m².

10. The laminated fabric of any one of claims 1-9 in which the Walz fabric density of the woven fabric is from 8 to 25%.

11. The laminated fabric of any one of claims 1-10 in which the polymeric material is a thermoplastic or elastomeric material.

12. The laminated fabric of claim 6 in which the polymeric material is formed from a thermoset material.

13. The laminated fabric of any one of claims 1-12 in which the penetration resistant yarn consists of at least one of aramid, polyethylene and poly-p-phenylene benzobisoxazole yarn.

14. The laminated fabric of any one of claims 1-13 in which the pitch (harness) of the satin woven fabric is from 5 to 9.

15. The laminated fabric of claim 14 in which the satin woven fabric has a jump count (progressive number) from 2 to 7.

16. The laminated fabric of any one of claims 1-15 in which the penetration resistant yarn has a tenacity of at least 1375 mN/tex.

17. A penetration resistant article comprising a plurality of laminated fabrics of any one of claims 1-16, said fabrics being laid one upon the other to form a packet of laminated fabrics.

18. The penetration resistant article of claim 17 in which the laminated fabrics in the packet are joined with each other.

19. The penetration resistant article of claim 17 or claim 18 in which the laminated fabrics in the packet are joined by quilting, gluing or other fixing means.

20. The penetration resistant article of claim 17 or claim 18 in which two or more fabrics are joined with each other by lamination.
